(19) United States
(12) Patent Application Publication
(10) Pub. No.: US 2011/0089700 A1
(43) Pub. Date: Apr. 21, 2011

(54) WALL MOUNTED WIND TURBINE AND METHODS OF USE AND INSTALLATION

(76) Inventor: Keith Alan Tully, Fishers, IN (US)

(21) Appl. No.: 12/906,037

(22) Filed: Oct. 15, 2010

Related U.S. Application Data
(60) Provisional application No. 61/252,631, filed on Oct. 16, 2009.

(51) Int. Cl. F03D 9/00; F03D 3/04; F03D 11/04; G09F 19/00

(52) U.S. Cl. 290/55; 415/213.1; 40/606.03

(57) ABSTRACT

The present invention is a wall mounted wind turbine used to produce power that includes a wind turbine that is mounted uprightly, a plurality of wind blades that are integral to the wind turbine that receives incoming exterior wind and that rotate around the wind turbine to produce power and a triangular-shaped wind guard that encapsulates and protects top, sides and back of the wind turbine and the wind blades, while allowing exterior wind to enter front of the wind turbine and enhancing the wind turbine performance. There is also advertising indicia disposed on the triangular-shaped wind guard to provide on-premises advertising that can be illuminated or non-illuminated. There is also a sign cabinet embodiment and method of use.

This application claims priority to U.S. Provisional Application 61/252,631 filed on Oct. 16, 2009, the entire disclosure of which is incorporated by reference.

### TECHNICAL FIELD & BACKGROUND

The present invention generally relates to a wall mounted wind turbine and methods of use and installation. More specifically, the invention is a wall mounted wind turbine with advertising and optional illumination and methods of use and installation.

It is an object of the invention to provide a wind turbine that can be mounted on a wall or other vertical surface.

It is an object of the invention to provide a wall mounted wind turbine that is illuminated.

It is an object of the invention to provide a wall mounted wind turbine that displays advertising.

What is really needed is an optionally illuminated wind turbine that provides advertising that can be mounted on a wall or other vertical surface and methods of use and installation.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a front perspective view of a wall mounted wind turbine, in accordance with one embodiment of the present invention.

FIG. 1B illustrates a diagonal overhead perspective view of a wall mounted wind turbine, in accordance with one embodiment of the present invention.

FIG. 2 illustrates a front side perspective view of a sign cabinet, in accordance with one embodiment of the present invention.

FIG. 3 illustrates a rear perspective view of a sign cabinet, in accordance with one embodiment of the present invention.

FIG. 4 illustrates a flow chart of a method of using a mounted wind turbine, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

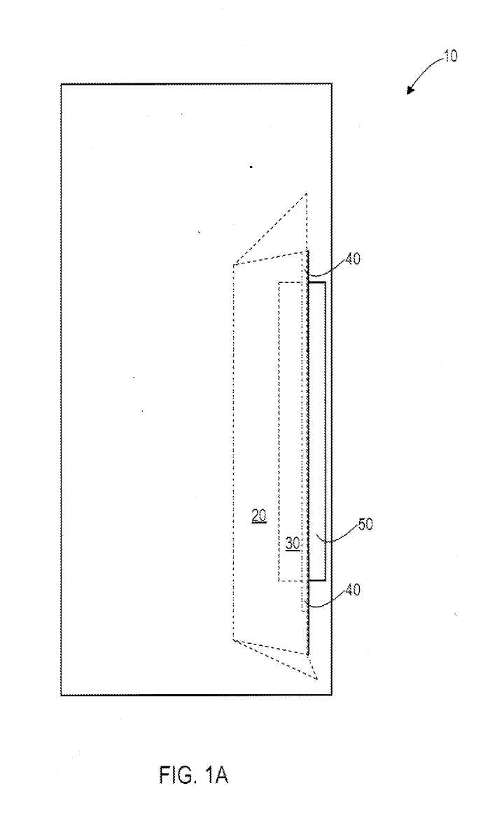

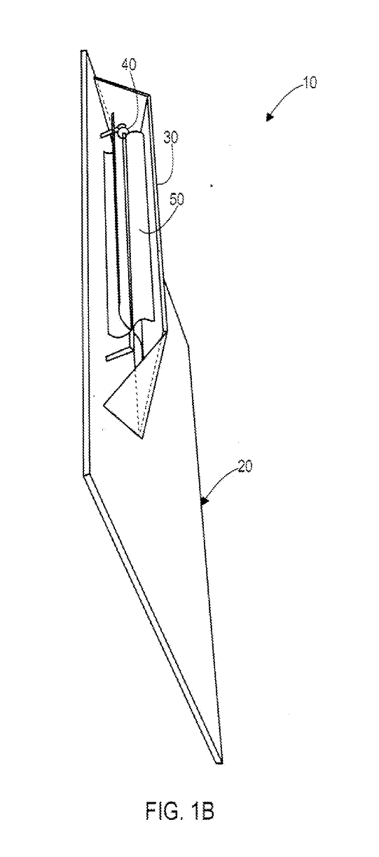

FIG. 1A illustrates a front perspective view of a wall mounted wind turbine 10, in accordance with one embodiment of the present invention. FIG. 1B illustrates a diagonal overhead perspective view of a wall mounted wind turbine 10, in accordance with one embodiment of the present invention. The wall mounted wind turbine 10 is designed to attach to a vertical surface or an external wall 20 of a building. The mounted wind turbine 10 would include a wind guard 30 that has a triangular-shape designed to both enhance the performance of the wall mounted wind turbine 10 and additionally act as a vehicle for on premises advertising. The wind guard 30 can be illuminated or non-illuminated. The wind guard 30 is designed to both enhance the performance of a wind turbine 40 and additionally act a vehicle for on premises advertising.

The wall mounted wind turbine 10 will save money by eliminating the need for traditional on-premises advertising such as an illuminated sign or awning and will generate electricity to be used by the business. Businesses need electrical energy to power their businesses. Businesses also need to identify their locations to their consumers and other interested parties through on premises advertising. As on-premise advertising has increased, businesses need a way to stand out from their competition. The added benefit of movement of a spinning turbine will enhance the advertising nature of my invention by attracting attention through movement.

Current wind turbines are not designed to mount on walls or other vertical surfaces which limit their usage. Current wind turbines may create noise and hurt wildlife. Attempts to overcome these issues have led to designs that do not optimize the performance of the turbine. Additionally, current illuminated awnings or signage do not generate electricity. The wall mounted wind turbine 10 adds a wind guard 30 that would encompass the lower half of the wind turbine 40 which will improve the performance of the wind turbine 40. Traditional cylindrical turbine designs have a flaw in that they must travel backward into the wind as they rotate in their circular motion. The wall mounted wind turbine 10 eliminates this problem by walling off the lower half of the wind turbine 40, allowing the wind blades 50 to never have to spin against the direction of the wind due to its triangular-shaped design. The wind guard 30 adds an additional safety benefit of guarding against ice or snow being thrown from the spinning wind turbine 40 onto the ground.

The wind guard 30 will have another benefit of providing a surface that can be utilized in the same fashion as any or all forms of illuminated and non-illuminated awnings or signs. The duel functionally of both generating electricity and providing on-premise advertising reduces the operating expenses of the company while offering superior advertising. The wind turbine 40 will be used to generate electricity and to advertise the business in the same ways that current electric signs or illuminated awnings are used to advertise.

The wall mounted wind turbine 10 is a device configured and designed to both generate electricity and provide on-premise advertising. The wall mounted wind turbine 10 consists of the wind blades 50 that capture wind energy, the wind turbine 40 that is an electrical turbine to convert the energy of the wind blades 50 into electricity and the wind guard 30 that both enhances the performance of the wind blades 50 and allows the owner to advertise in the same fashion as an illuminated or non-illuminated sign or awning. The wind guard 30 is attached to the external wall 20 or vertical surface and is used to deflect the wind toward the wind blades 50 while also shielding the lower half of the wind blades 50 from having to travel in the opposite direction of the wind. The net result is an increase in the wind speed going over the wind blades 50 and a reduction of drag on the bottom of the wind blades 50. Both factors will increase the amount of energy the wind blades 50 are able to capture.

An addition function of the wind guard 30 is that it may also be used in all the same ways that a sign or awning is used. The wind guard 30 can be printed with graphics and internally illuminated as an illuminated awning used to advertise or conventional illuminated or non-illuminated signage can be attached to the wind guard 30 structure as well. The wind guard 30 would not necessarily need to be used as signage but could also provide this additional benefit.

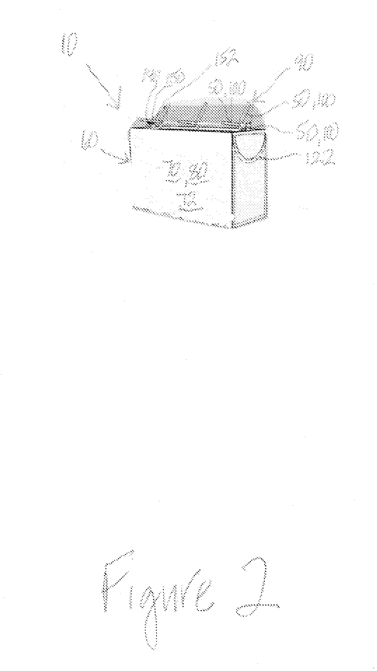

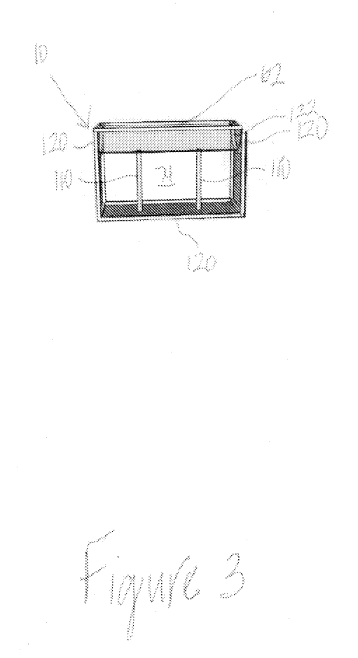

FIG. 2 illustrates a front side perspective view of a sign cabinet 60, in accordance with one embodiment of the present invention. FIG. 3 illustrates a rear perspective view of a sign cabinet 60, in accordance with one embodiment of the present invention. The sign cabinet 60 has a sign 70 that has a flex-face with a surface vinyl graphics 80. A rotor 90 will extend a maximum of 12″ above sign cabinet 60. The rotor 90 is 18″ in diameter and has 3 wind blades 50 with each wind blade 50 making one full rotation around the turbine 40. The rotor 90 is mounted on 3 sets armatures 100 with an armature 100 for each wind blade 50 that will extend outward at 120 degrees from the turbine 40. Polycarbonate sheeting is cut to match the curve of the sign 70 and is decorated with a blue and green stripe to match green and blue stripe at bottom of the sign 70, although other decorations that are well known in the art can be used. The sign 70 is double sided flex facing with a front side 72 to have a logo and a back side 74 to have a white substrate. The sign cabinet 60 also includes two 1.25″ diameter drainage tubes 110. The top 62 of the sign cabinet 60. is a clear substrate. A frame 120 with a curved section 122 is rolled 1″ square tubing. Polycarbonate is fastened to the frame 120 with a plurality of screws 130. The rotor 90 is mounted to a flange bearing 140 mounted to a mounting plate 150 welded to the top 62 of the sign cabinet 60. The mounting plate 150 has a plurality of mounting holes 152 drilled to match the flange bearing 140 and to have a center section notched to accommodate the turbine 40.

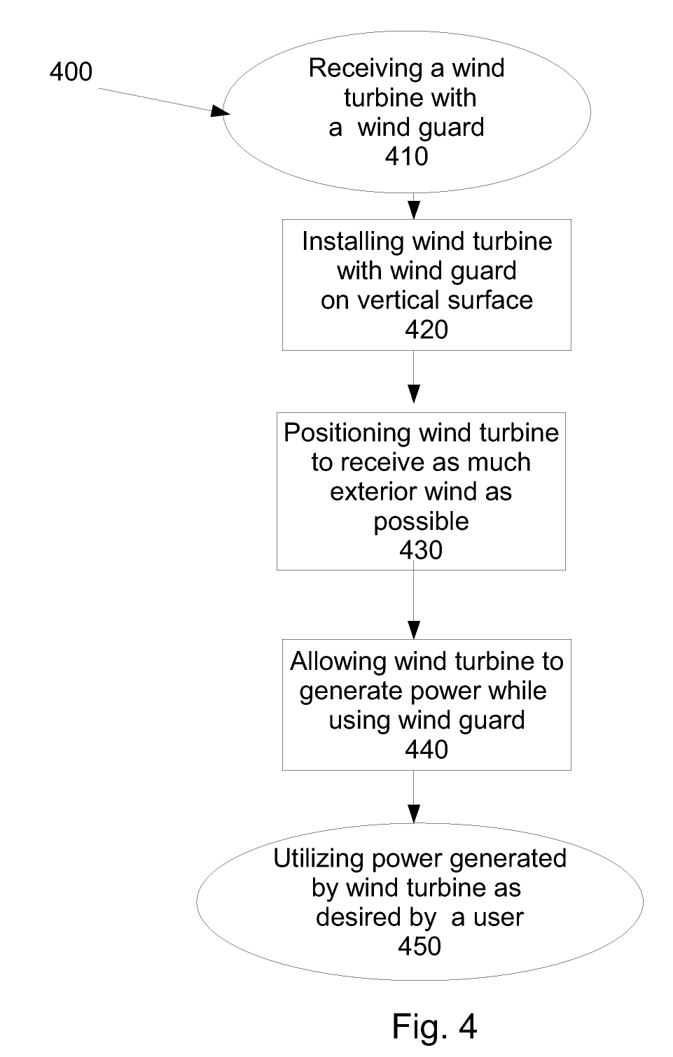

FIG. 4 illustrates a flow chart of a method 400 of using a wind turbine with a plurality of wind blades, in accordance with one embodiment of the present invention. The steps of the method 400 of using a wind turbine with a plurality of wind blades include receiving the wind turbine with a triangular-shaped wind guard 410, installing the wind turbine with the triangular-shaped wind guard on a vertical surface 420, positioning the wind turbine to receive as much exterior wind as possible 430, allowing the wind turbine to generate power with the triangular-shaped wind guard 440 and utilizing power generated by the positioned wind turbine as desired by a user 450. The method 400 and the vertical surface include an exterior wall of a building or other outside structure that is well known in the art. The method 400 utilizes the wind guard that walls off a lower half of the wind turbine to prevent the wind blades from spinning backwards and that also increases the incoming exterior wind speed moving over the wind blades.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A mounted wind turbine used to produce power, comprising:
a wind turbine that is mounted uprightly;
a plurality of wind blades that are integral to said wind turbine that receives incoming exterior wind and rotate around said wind turbine to produce power;
a wind guard that encapsulates and protects top, sides and back of said wind turbine and said winds blades, while allowing exterior wind to enter front of said wind turbine and enhancing said wind turbine performance; and
advertising indicia disposed on said wind guard to provide on-premises advertising.

2. The mounted wind turbine according to claim 1, wherein said wind turbine is an electrical wind turbine that produces electrical power.

3. The mounted wind turbine according to claim 1, wherein said wind guard has a generally triangular shape.

4. The mounted wind turbine according to claim 1, wherein said wind guard walls off a lower half of said wind turbine to prevent said wind blades from rotating backwards.

5. The mounted wind turbine according to claim 4, wherein said wind guard increases said incoming exterior wind speed moving over said wind blades.

6. The mounted wind turbine according to claim 1, wherein said wind guard prevents said wind turbine from throwing rain and snow outside of said turbine.

7. The mounted wind turbine according to claim 1, wherein said advertising indicia is illuminated or non-illuminated.

8. The mounted wind turbine according to claim 1, wherein said illuminated advertising illumination is provided by said wind turbine.

9. The mounted wind turbine according to claim 1, wherein said advertising indicia includes advertising graphics and signage.

10. The mounted wind turbine according to claim 1, wherein said wind turbine is mounted on a vertical surface.

11. The mounted wind turbine according to claim 10, wherein said wind turbine is mounted on an exterior wall of a building or other outdoor structure.

12. A method of using a wind turbine with a plurality of wind blades, comprising:
receiving said wind turbine with a triangular-shaped wind guard;
installing said wind turbine with said triangular-shaped wind guard on a vertical surface;
positioning said wind turbine to receive as much exterior wind as possible;
allowing said wind turbine to generate power with said triangular-shaped wind guard; and
utilizing power generated by said positioned wind turbine as desired by a user.

13. The method according to claim 12, wherein said vertical surface includes an exterior wall of a building or other structure.

14. The method according to claim 12, wherein said triangular-shaped wind guard walls off a lower half of said wind turbine to prevent said wind blades from spinning backwards.

15. The method according to claim 12, wherein said triangular-shape wind guard increases said incoming exterior wind speed moving over said wind blades.

16. A sign cabinet apparatus with a top, comprising:
a sign with a front side and a back side that has a flex-face with surface vinyl graphics;
a wind turbine that is horizontally mounted within said sign cabinet;
a rotor extending above said sign cabinet with a plurality of wind blades, wherein said wind blades are attached to and rotate around said wind turbine;
a plurality of armatures mounted on said rotor with one said armature with one said wind blade that extend outward from said turbine;
a plurality of drainage tubes;
a frame with a curved section to support said sign
a flange bearing which mounts said rotor mounted to a mounting plate welded to said top said sign cabinet and has a center section notched to accommodate said turbine.

17. The apparatus according to claim 16, wherein polycarbonate sheeting is cut to match a curve of said sign.

18. The apparatus according to claim 16, wherein said sign is double sided flex facing with said front side having a logo and said back side having a white substrate.

19. The apparatus according to claim 16, wherein said sign is fastened to said frame with a plurality of screws.

20. The apparatus according to claim 16, wherein said mounting plate has a plurality of mounting holes drilled to match said flange bearing
